(19) United States
(12) Patent Application Publication
(10) Pub. No.: US 2021/0019543 A1
(43) Pub. Date: Jan. 21, 2021

(54) METHOD AND APPARATUS FOR FACE RECOGNITION

(71) Applicant: Alibaba Group Holding Limited, George Town, Grand Cayman (KY)

(72) Inventor: Yuewei Zeng, Hangzhou (CN)

(73) Assignee: Alibaba Group Holding Limited, George Town, Grand Cayman (KY)

(21) Appl. No.: 16/959,642

(22) PCT Filed: Jan. 30, 2019
(86) PCT No.: PCT/CN2019/073829

§ 371 Date: Jul. 1, 2020

(30) Foreign Application Priority Data
Apr. 4, 2018 (CN) 201810301816.6

(51) Int. Cl. G06K 9/03; G06K 9/00; G06K 9/32

(52) U.S. Cl. CPC G06K 9/036; G06K 9/3208; G06K 9/00288

(57) ABSTRACT

The disclosed embodiments provide a face-recognition method and apparatus. The face-recognition method comprises: receiving a face-recognition request from a client; searching, according to a device model of a device in the face-recognition request, a zero-pass-rate-model-configuration table for the device; if the device is found, acquiring angle-configuration information corresponding to the device model from the zero-pass-rate-model-configuration table; and returning the angle-configuration information to the client, thereby facilitating the client in configuring the device according to the angle configuration information and performing face recognition using the configured device.

### BACKGROUND

### Field

One or a plurality of embodiments of the disclosure relate to the technical field of computers, and in particular to a method and apparatus for face recognition.

### Related Art

In conventional technologies, when a user performs face recognition using a device, if a display angle of an image captured by a camera of the device is wrong or if a recognition angle of a face-recognition algorithm is wrong, the device may fail to perform face recognition. Therefore, face-recognition pass rates of certain devices can be zero.

### SUMMARY

One or a plurality of disclosed embodiments describe a face-recognition method and apparatus that can improve the face-recognition success rate.

One aspect provides a face-recognition method. The method can include:

receiving a face-recognition request from a client, the face-recognition request comprising a device model of a device where the client is residing;

searching a zero-pass-rate-model-configuration table for the device according to the device model, the zero-pass-rate-model-configuration table configured to store a corresponding relationship between a device model having a zero face-recognition pass rate and angle-configuration information of the device model, and the angle-configuration information determined according to data recorded by an event-tracking mechanism of the client while capturing user face-recognition behaviors;

if the device is found in the table, acquiring angle-configuration information corresponding to the device model;

returning the angle-configuration information to the client, such that the client can configure the device according to the angle-configuration information and perform face recognition using the configured device.

In a second aspect, a face-recognition method is provided. The method can include:

sending a face-recognition request to a server, the face-recognition request comprising a device model of a device where the client is residing; the face-recognition request configured to instruct the server to search a zero-pass-rate-model-configuration table for the device according to the device model;

receiving a response returned by the server;

if the response comprises information indicating that the device has been found and angle-configuration information corresponding to the device, configuring the device according to the angle-configuration information; and

performing face recognition using the configured device.

In a third aspect, a face-recognition apparatus can be provided. The face-recognition apparatus can include:

a receiving unit configured to receive a face-recognition request from a client, the face-recognition request comprising a device model of a device where the client is residing;

a search unit configured to search a zero-pass-rate-model-configuration table for the device according to the device model received by the receiving unit, the zero-pass-rate-model-configuration table configured to store a corresponding relationship between a device model having a zero face-recognition pass rate and angle-configuration information of the device model; the angle configuration information determined according to data recorded by an event-tracking mechanism of the client while capturing user face-recognition operations;

an acquisition unit configured to acquire angle configuration information corresponding to the device model, in response to the search unit finding the device;

a sending unit configured to return to the client the angle-configuration information acquired by the acquisition unit, such that the client can configure the device according to the angle-configuration information and perform face recognition using the configured device.

In a fourth aspect, a face-recognition apparatus is provided. The face-recognition apparatus can include:

a sending unit configured to send a face-recognition request to a server, the face-recognition request comprising a device model of a device within which the face recognition apparatus is located; the face recognition request configured to instruct the server to search a zero-pass-rate-model-configuration table for the device according to the device model;

a receiving unit configured to receive a response returned by the server;

a configuration unit configured to configure the device according to the angle-configuration information, in response to determining that the response received by the receiving unit comprises information indicating that the device has been found and corresponding angle-configuration information;

a recognition unit configured to perform face recognition using the device configured by the configuration unit.

One or a plurality of the disclosed embodiments can provide a face-recognition method and apparatus that receives a face-recognition request from a client; searches a zero-pass-rate-model-configuration table based on a device model specified by the face-recognition request; if the device is found, acquire angle-configuration information corresponding to the device model from the zero-pass-rate-model-configuration table; and return the angle-configuration information to the client, such that the client can configure the device according to the angle-configuration information and perform face recognition using the configured device. Therefore, the success rate of the face-recognition method can be improved.

### BRIEF DESCRIPTION OF THE FIGURES

To describe the technical solutions of the disclosed embodiments more clearly, the following descriptions briefly introduces the accompanying drawings for describing the embodiments. It is apparent that the accompanying drawings described below are only a part of the disclosed embodiments, and those of ordinary skill in the art may be able to derive other drawings from these accompanying drawings without creative efforts.

FIG. 1 presents a schematic diagram of an application scenario of a face-recognition method, according to one embodiment.

FIG. 2 presents a flowchart illustrating an exemplary process of generating a zero-pass-rate-model-configuration table, according to one embodiment.

FIG. 3 presents a flowchart illustrating an exemplary process of a face-recognition method, according to one embodiment.

FIG. 4 presents a flowchart illustrating an exemplary process of an alternative face-recognition method, according to one embodiment.

FIG. 5 presents a schematic diagram of a face-recognition apparatus, according to one embodiment.

FIG. 6 presents a schematic diagram of an alternative face-recognition apparatus, according to one embodiment.

### DETAILED DESCRIPTION

The disclosed solutions are described below with reference to the accompanying drawings.

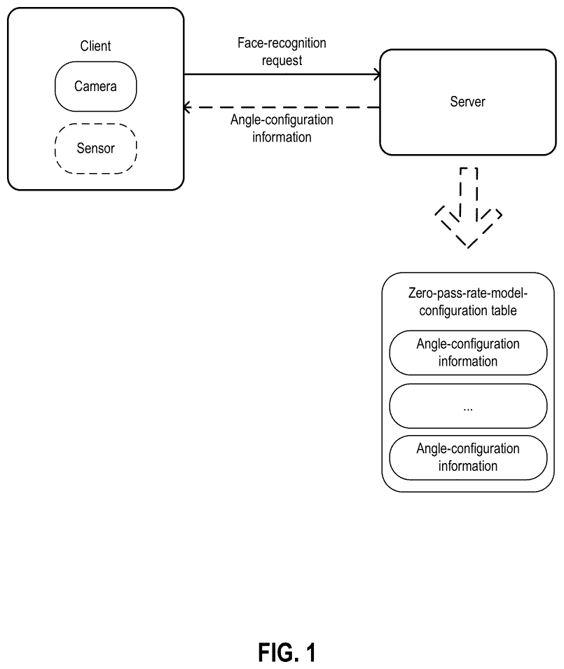

A face-recognition method provided by a disclosed embodiment can be applied to a scenario shown in FIG. 1. In FIG. 1, a client application can be associated with a camera. The camera can be provided as part of a device where the client application is residing, or can be externally connected to the device. The aforementioned device can be, for example, a mobile phone, a tablet computer, etc. The device can have a corresponding operating system. The operating system can be an Android system having a default window (view). The window may also be referred to as a built-in window of the device. The built-in window refers to a general view. In addition, the device may further have a corresponding external window. The external window may also be referred to as a display window (display). The display can also be referred to as an interface rendered by the camera. The built-in window or view of the device generally cannot be reconfigured and is controlled by the Android system. On the other hand, the display of the device can be reconfigured. For example, a display-rotation angle of the display can be configured.

It should be noted that the device where the client application is residing may further include a corresponding sensor. A deployment direction of the device can be determined according to data sensed by the sensor. The deployment direction includes a normal direction and an inverted direction. In addition, the device may further have a built-in face-recognition algorithm. The face-recognition algorithm can have a corresponding algorithm-recognition angle. Specifically, the device can be configured to perform face recognition using the built-in face-recognition algorithm.

In FIG. 1, a server can generate a zero-pass-rate-model-configuration table in advance. The zero-pass-rate-model-configuration table can be configured to store a corresponding relationship between a device having a zero face-recognition pass rate and angle-configuration information of the device. The aforementioned device having a zero face-recognition pass rate can also be referred to as a zero-pass-rate model. Specifically, during face recognition, if the device where the client is residing is a zero-pass-rate model, then corresponding angle-configuration information can be acquired from the zero-pass-rate-model-configuration table, and the acquired angle-configuration information can be returned to the client. The client can then configure the device according to the angle-configuration information and perform face-recognition using the configured device.

The aforementioned angle-configuration information can include a display-rotation angle and an algorithm-recognition angle. The display-rotation angle refers to a rotation angle of the display of the device and can be determined according to a rotation angle of the built-in view. The rotation angle of the built-in view can be acquired by calling an Application Programming Interface (API) function provided by the Android system. The method to determine the display rotation angle can be a standard method, and details will not be described herein again. The algorithm-recognition angle refers to an angle used by the face-recognition algorithm of the device. In one embodiment, the algorithm-recognition angle can be determined according to the following formula: abs (360°—display-rotation angle).

It should be understood that, when the angle-configuration information includes a display-rotation angle and an algorithm-recognition angle, the aforementioned process of configuring the device can include: configuring the display-rotation angle of the display of the device according to the display-rotation angle, and configuring the algorithm-recognition angle of the face-recognition algorithm implemented by the device according to the algorithm-recognition angle.

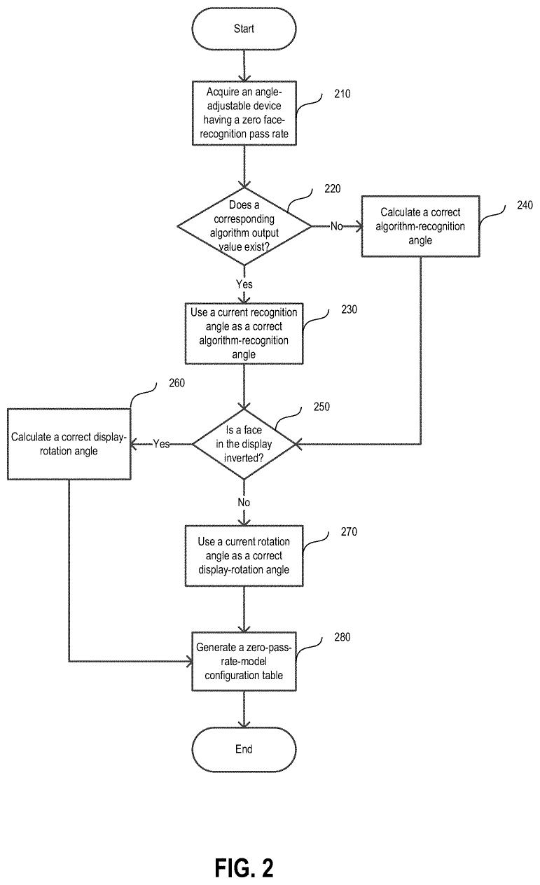

It can be seen from FIG. 1 that in order to enable a device being a zero-pass-rate model to perform face recognition, the zero-pass-rate-model-configuration table can be generated in advance. FIG. 2 presents a flowchart illustrating an exemplary process of generating a zero-pass-rate-model-configuration table, according to one embodiment. According to FIG. 2, the method can include a number of operations.

In operation 210, an angle-adjustable device having a zero face-recognition pass rate is acquired.

The face-recognition pass rate herein may include a number pass rate and an account pass rate. In some embodiments, the number pass rate and the account pass rate of the device can be counted on the basis of a plurality of users. Specifically, the number pass rate can be determined according to the total number of face-recognition operations performed by the plurality of users while using the device and the number of successful operations. For example, if the total number of face-recognition operations performed by 50 users using the device is 100 and the number of successful operations is 60, then the number pass rate of the device is 60%. The account pass rate can be determined according to the total number of users that perform face-recognition operations using the device and the number of users successfully recognized. For example, if the total number of users that perform face-recognition operation using the device is 50, and the number of users successfully recognized is 30, then the account pass rate of the device is 60%. It should be noted that, when determining the account pass rate, if a user performs face recognition a plurality of times using the device, and if recognition succeeds once or more, the user is successfully recognized.

In one embodiment, the process of acquiring a device having a zero face-recognition pass rate can include: acquiring a plurality of devices in advance, and for each of the plurality of devices, acquiring user-behavior data associated with the device. The user-behavior data herein may be recorded by an event-tracking mechanism (e.g., a data-recording mechanism) of a client when capturing that a user starts a face-recognition operation and completes the face-recognition operation and/or abandons the face-recognition operation using the device. A face-recognition pass rate of each device can be determined according to the user-behavior data corresponding to the device. The user behavior-data herein may include information such as an account identifier, a device model, time, etc. The face-recognition pass rate may refer to the number pass rate and/or the account pass rate. Specifically, the total number of face-recognition operations performed using each device and the number of successful operations can be counted according to the information included in the user-behavior data, such as the account identifier, the device model, the time, etc. A corresponding number pass rate can be calculated for each device. Alternatively, for each device, the total number of users performing face-recognition operations using the device and the number of users being successfully recognized are counted, and a corresponding account pass rate is calculated. A particular device having a zero face-recognition pass rate (e.g., the number pass rate and/or the account pass rate) is selected from the plurality of devices.

The angle-adjustable device in operation 210 can be referred to a device having a front camera and a rear camera, and/or a device on a whitelist. Herein, devices can be added to the whitelist manually in advance.

In operation 220, it is determined whether the device has a corresponding algorithm output value.

The algorithm output value herein is outputted when the device successfully performs a face-recognition operation, and it include information such as a facial quality score, a position, and facial coordinates. Specifically, the aforementioned algorithm output value may be recorded by the event-tracking mechanism of the client while capturing that the user performs face recognition successfully using the device. It should be understood that, if the algorithm-recognition angle is wrong, then the face-recognition algorithm fails, and the device fails in performing facial recognition. When the device fails in performing facial recognition, no corresponding algorithm output value is acquired.

Therefore, it can be determined whether a currently used algorithm-recognition angle is correct by determining whether the device has a corresponding algorithm output value.

In operation 230, if it is determined that the device has a corresponding algorithm output value, then a current recognition angle of the device is acquired, and the current recognition angle is used as an algorithm-recognition angle.

The current recognition angle herein may refer to an algorithm-recognition angle used by the face-recognition algorithm during the face-recognition operation performed by the device. The current recognition angle may also be recorded by the event-tracking mechanism of the client. For example, the current recognition angle may be recorded by the event-tracking mechanism when capturing that the user uses the device to perform face recognition.

In operation 240, if it is determined that the device does not have a corresponding algorithm output value, then a current recognition angle of the device is acquired, and the current recognition angle can be corrected to obtain an algorithm-recognition angle.

In one example, the current recognition angle can be corrected according to the following formula: abs (360°—current recognition angle). After the correction, a correct algorithm-recognition angle can be obtained.

In operation 250, it is determined whether a face displayed in a display of the device is inverted.

In one embodiment, the process of determining whether a face displayed in the display of the device is inverted can include: acquiring sensor data of the device and display data of the face captured by a camera of the device, with the sensor data and the display data being recorded by the event-tracking mechanism of the client when capturing the user performing a successful face-recognition operation using the device with a default configuration. It is determined, according to the sensor data and the display data, whether the face displayed in the display of the device is inverted.

For example, the aforementioned sensor data can include three-dimensional (3D) coordinates: x, y, and z. A deployment direction of the device can be determined according to the 3D coordinates. The deployment direction can include a normal direction and an inverted direction. The aforementioned display data may refer to the coordinates of point at the upper left corner and the coordinates of a point at the lower right corner of the face. Specifically, when the deployment direction of the device is the normal direction, if the coordinates of the point at the upper left corner are less than the coordinates of point at the lower right corner, then the face displayed in the display of the device is not inverted; otherwise, the face is inverted. When the deployment direction of the device is the inverted direction, the aforementioned determination process is not performed. That is, the disclosed embodiments only deal with the case, in which the deployment direction of the device is the normal direction.

In operation 260, if it is determined that the face displayed in the display of the device is inverted, then a current rotation angle of the display is acquired, and the current rotation angle is corrected in order to obtain a display-rotation angle.

The current rotation angle may also be recorded by the event-tracking mechanism installed in the client. For example, the current recognition angle may be recorded by the event-tracking mechanism when capturing that the user uses the device to perform face recognition. Specifically, if the face is inverted, then it is indicated that the current rotation angle is wrong, and that the current rotation angle needs to be corrected. In one example, the current rotation angle can be corrected according to the following formula: abs(360°—current rotation angle). After the correction, a correct display rotation angle is obtained.

In operation 270, if it is determined that the face displayed in the display of the device is not inverted, then a current rotation angle of the display view is acquired, and the current rotation angle is used as a display rotation angle.

If the face is not inverted, then the current rotation angle is correct, and the current rotation angle does not need to be corrected.

In operation 280, a zero-pass-rate-model-configuration table is generated according to the device model of the angle-adjustable device having a zero face-recognition pass rate, the algorithm-recognition angle, and the display-rotation angle.

It should be understood that, for an angle-adjustable device having a zero face-recognition pass rate, after the corresponding algorithm-recognition angle and the corresponding display-rotation angle are determined, the zero-pass-rate-configuration table can be generated.

Certainly, in practical applications, for some devices having zero face-recognition pass rates, if the event-tracking mechanism of the client does not capture or fails to capture a face-recognition operation performed by the user, then the server cannot determine angle-configuration information of the device. Therefore, the zero-pass-rate-model-configuration table does not record the angle-configuration information of these devices.

In one example, the generated zero-pass-rat-model-configuration table may be as shown in Table 1:

TABLE 1

| | Display-rotation | Algorithm-recognition |
|---|---|---|
| Zero pass rate device model | angle | angle |
| X9S | X | 360 - X |
| V9 play | Y | 360 - Y |
| R11s Plus | NULL | NULL |
| . . . | . . . | . . . |

In Table 1, X, Y, and Z can be 90 degrees or 270 degrees. “NULL” indicates that the angle-configuration information of a device of the device model is null.

After the aforementioned zero-pass-rate-model configuration table is generated, face recognition operations can be performed.

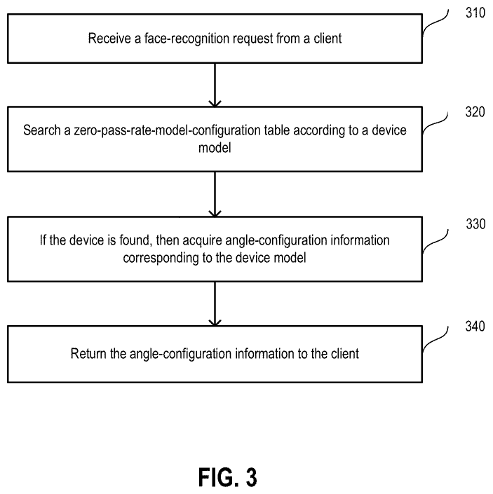

FIG. 3 presents a flowchart illustrating an exemplary process of a face-recognition method, according to one embodiment. The method can be executed by a server. As shown in FIG. 3, the method can include a number of operations.

In operation 310, a face-recognition request from a client is received.

The face-recognition request may include a device model of a device where the client is residing.

Using the Alipay™ client as an example, when a user clicks on a beta button “login with a face ID” on a login page of the Alipay client, the client can send the aforementioned face-recognition request to the server.

In operation 320, a zero-pass-rate-model-configuration table is searched based on the device model included in the face-recognition request.

For example, the device model can be compared with each of the device-model entries in Table 1. If a matching device-model entry is found in Table 1, then the device is found. It should be understood that, if the device is found in the table, the device belongs to a device model with a zero face-recognition pass rate. Otherwise, the device is not found.

In operation 330, if the device is found, then angle-configuration information corresponding to the device model is acquired.

In the aforementioned example, assuming that the device model is the same as a device model in row 2 of Table 1, then the angle configuration information Y and 360-Y corresponding to the device model can be acquired.

In operation 340, the angle-configuration information can be returned to the client.

After receiving the angle-configuration information returned by the server, the client can configure the device according to the angle-configuration information and perform face-recognition operations using the configured device. In the aforementioned example, the process of configuring the device can include: configuring a display-rotation angle of a display of the device to be Y, and configuring an algorithm-recognition angle of a face recognition algorithm of the device to be 360°-Y.

It should be noted that, if the server has found the device, but the corresponding angle-configuration information in the table is null, then the client can activates the default configuration to perform the face recognition operation. The default configurations herein may refer to that the angle-configuration information of the device is configured by the Android operating system.

In addition, if the server has not found the device, then the client acquires a rotation angle of a built-in view of the device. The display-rotation angle is determined according to the rotation angle of the built-in view. The algorithm-recognition angle can be determined according to the display-rotation angle. The device is configured according to the determined display-rotation angle and the determined algorithm-recognition angle. Face recognition can be performed using the configured device. It should be noted that determining the display-rotation angle and the algorithm-recognition angle can include standard operations and details regarding these operations will not be described herein again.

In this embodiment, the server generates a zero-pass-rate-model-configuration table, and the angle-configuration information is delivered to the client to improve the success rate of face recognition.

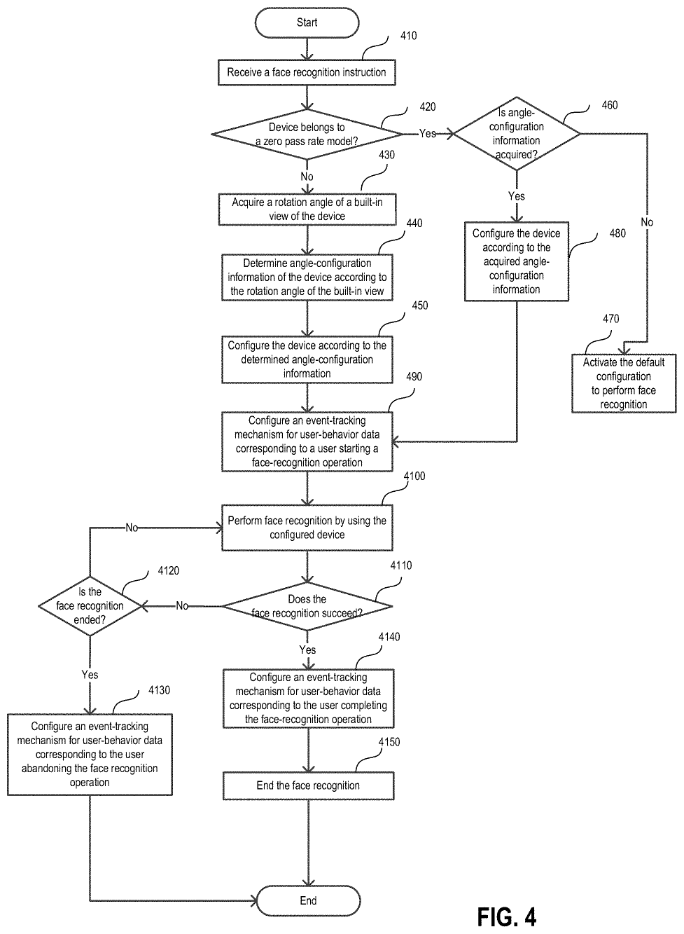

FIG. 4 presents a flowchart illustrating an exemplary process of an alternative face-recognition method, according to one embodiment. The method can be executed by a client. As shown in FIG. 4, the method can include:

In operation 410, a face-recognition command is received by a client.

Using Alipay client as an example, the aforementioned face-recognition command can be triggered by a user clicking on a beta button “login with face” on the login page of the Alipay client.

In operation 420, it is determined whether a device where the client is residing belongs to a zero pass rate model. If not, operations 430 to 450 can be performed; if so, operation 460 is performed.

Specifically, the client can send a face-recognition request to a server. The face-recognition request may include a device model of the device where the client is residing. The server can search a zero-pass-rate-model-configuration table for the device according to the device model. A response is returned to the client. If the response indicates that the device has been found in the table, it is determined that the device belong to a zero pass rate model. Otherwise, it is determined that the device does not belong to a zero pass rate model.

In operation 430, a rotation angle of a built-in view of the device is acquired.

In operation 440, angle-configuration information of the device is determined according to the rotation angle of the built-in view.

The angle-configuration information may include a display-rotation angle and an algorithm-recognition angle. Specifically, the display-rotation angle is determined according to the rotation angle of the built-in view, and an event-tracking mechanism can be automatically configured for the display-rotation angle. It should be understood that the event-tracking mechanism herein corresponds to the event-tracking mechanism mentioned in operation 260. The aforementioned display-rotation angle determination method can include standard operations and its details will not be described herein again. The algorithm-recognition angle can be determined according to the display-rotation angle, and an event-tracking mechanism can be automatically configured for the algorithm-recognition angle. It should be understood that the event-tracking mechanism herein corresponds to the event-tracking mechanism mentioned in operation 230. In one embodiment, the algorithm-recognition angle can determined as following formula: abs(360°—display-rotation angle).

In operation 450, the device is configured according to the determined angle-configuration information.

In operation 460, it is determined whether corresponding angle-configuration information can be acquired. If not, operation 470 is performed; if so, operation 480 is performed.

Herein, it can be determined, according to the response from the server, whether the corresponding angle-configuration information can be acquired. Specifically, if the response further includes the corresponding angle-configuration information, then it is determined that the corresponding angle-configuration information can be acquired. The angle-configuration information may include a display-rotation angle and an algorithm-recognition angle.

In operation 470, a device with the default configuration is activated to perform face recognition.

Herein, the process of performing, by the device with the default configuration, face recognition can include: (a) capturing a screenshot; (b) identifying, using a built-in face-recognition algorithm of the device, whether a face exists in the screenshot; (c) if not, then repeatedly performing steps (a) and (b); or if so, performing step (d); and (d) automatically configuring a event-tracking mechanism for sensor data of the device and display data of the face captured by a camera of the device. Then, the client can upload the sensor data and the display data to the server.

It should be understood that the event-tracking mechanism herein corresponds to the event-tracking mechanism mentioned in operation 250.

In operation 480, the device can configured according to the acquired angle-configuration information.

In operation 490, an event-tracking mechanism can be automatically configured for user-behavior data corresponding to the user starting a face-recognition operation.

Specifically, the event-tracking mechanism captures that the user starts the face-recognition operation, and then records corresponding user-behavior data. It should be understood that the event-tracking mechanism herein corresponds to the event-tracking mechanism mentioned in operation 210.

In operation 4100, face recognition is performed by using the configured device.

In operation 4110, it is determined whether the face-recognition operation succeeds. If not, operation 4120 is performed; if so, operation 4140 is performed.

In operation 4120, it is determined whether to end the face-recognition operation. If not, operation 4100 is performed; if so, operation 4130 is performed.

In operation 4130, an event-tracking mechanism is automatically configured for user-behavior data corresponding to the user abandoning the face-recognition operation.

Specifically, the event-tracking mechanism captures that the user abandons the face-recognition operation, and then records corresponding user-behavior data. It should be understood that the event-tracking mechanism herein corresponds to the event-tracking mechanism mentioned in operation 210.

In operation 4140, an event-tracking mechanism is automatically configured for user-behavior data corresponding to the user completing the face-recognition operation.

Specifically, the event-tracking mechanism captures that the user completes the face-recognition operation, and then records corresponding user-behavior data. It should be understood that the event-tracking mechanism herein corresponds to the event-tracking mechanism mentioned in operation 210.

In addition, an event-tracking mechanism can be automatically configured for an algorithm output value corresponding to the user completing the face-recognition operation. That is, an event-tracking mechanism can be automatically configured for an effective face-recognition algorithm. The event-tracking mechanism captures that the user completes the face-recognition operation, and records an algorithm output value corresponding to the face-recognition algorithm. The event-tracking mechanism herein corresponds to the event-tracking mechanism mentioned in operation 220.

In operation 4150, the face recognition ends.

In this embodiment, an event-tracking mechanism can be automatically configured to capture data of the client to facilitate the calculation of the correct angle-configuration information of the zero pass rate model, such that all devices implementing an Android operation system can perform face recognition. In addition, because the aforementioned configuration and calculation involve no manual effort, the success rate of face recognition can be greatly improved without affecting the efficiency of the face recognition method.

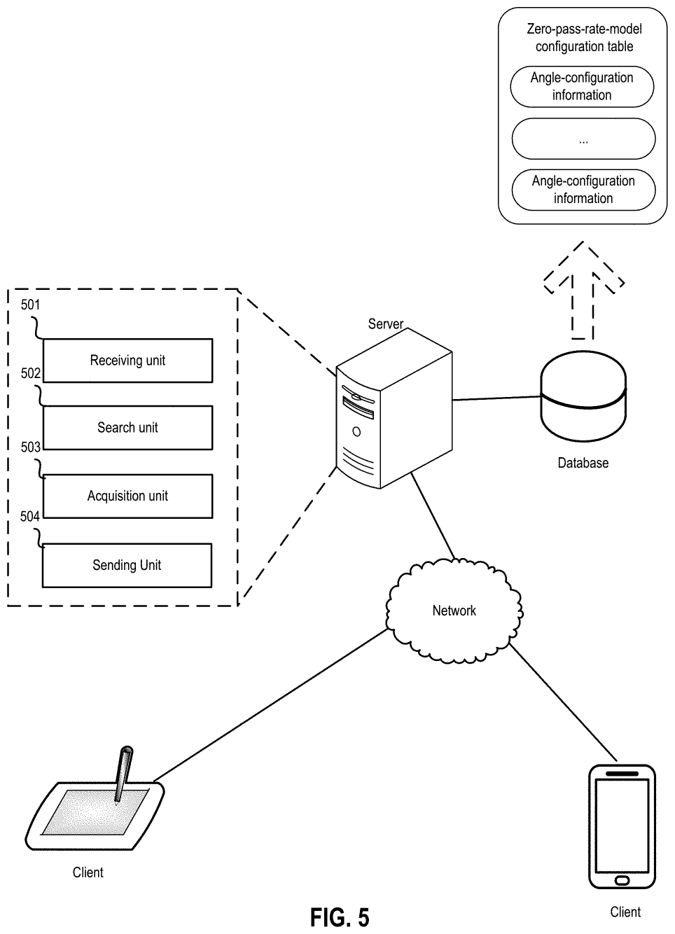

An embodiment can further provide a face-recognition apparatus corresponding to the aforementioned face-recognition method. As shown in FIG. 5, the apparatus can include:

a receiving unit 501 configured to receive a face-recognition request from a client, with the face-recognition request including a device model of a device where the client is residing;

a search unit 502 configured to search a zero-pass-rate-model-configuration table for the device according to the device model specified by the request received by receiving unit 501. The zero-pass-rate-model-configuration table can be configured to store a corresponding relationship between a device model having a zero face-recognition pass rate and angle-configuration information, and the angle configuration information can be determined according to data recorded by an event-tracking mechanism of the client when capturing a face-recognition operation of a user;

an acquisition unit 503 configured to acquire angle-configuration information corresponding to the device model, in response to search unit 502 finding the device;

an sending unit 504 configured to return to the client the angle-configuration information acquired by acquisition unit 503, such that the client can configure the device according to the angle-configuration information and perform face recognition using the configured device.

Optionally, the aforementioned angle-configuration information can include a display-rotation angle and an algorithm-recognition angle. The apparatus may further include a generation unit 505.

Generation unit 505 can be configured to:

acquire an angle-adjustable device having a zero face-recognition pass rate;

determine whether the device has a corresponding algorithm output value, which is outputted when the device performs face recognition successfully;

if so, acquire a current recognition angle of the device, and use the current recognition angle as the algorithm-recognition angle, where the current recognition angle refers to an angle used during face recognition performed by the device by using a face recognition algorithm;

if not, then acquire a current recognition angle of the device, and correct the current recognition angle to obtain the algorithm-recognition angle;

determine whether a face displayed in a display view of the device is inverted;

if so, acquire a current rotation angle of the display, and correct the current rotation angle in order to obtain the display-rotation angle;

if not, acquire a current rotation angle of the display, and use the current rotation angle as the display-rotation angle;

generate the zero-pass-rate-model-configuration table according to the device model of the angle-adjustable device having a zero face-recognition pass rate, the algorithm-recognition angle, and the display-rotation angle.

Optionally, generation unit 505 may be specifically configured to:

acquire a plurality of devices in advance;

for each of the plurality of devices, acquire user-behavior data corresponding to the device, where the user behavior data is recorded by an event-tracking mechanism of the client when capturing that a user uses a device to start a face-recognition operation, as well as complete the face-recognition operation and/or abandon the face-recognition operation;

determine a face-recognition pass rate of each device according to the user-behavior data corresponding to the device;

select a device having a zero face-recognition pass rate from the plurality of devices.

Optionally, generation unit 505 may further be specifically configured to:

acquire sensor data of the device and display data of the face captured by a camera of the device, where the sensor data and the display data are recorded by an event-tracking mechanism of the client when capturing that the user performs face recognition successfully using a device with default configuration;

determine, according to the sensor data and the display data, whether the face displayed in the display of the device is inverted.

The functions of functional modules of the apparatus in the aforementioned embodiment can be implemented by the operations described in the aforementioned method embodiments. Therefore, a specific operation process of an apparatus provided by an embodiment will not be described herein again.

In the face-recognition apparatus provided by an embodiment, receiving unit 501 receives the face-recognition request from the client. Search unit 502 searches the zero-pass-rate-model-configuration table for the device according to a device model. If the device is found, acquisition unit 503 acquires angle-configuration information corresponding to the device model. Sending unit 504 returns the angle-configuration information to the client, such that the client can configure the device according to the angle-configuration information and perform face recognition using the configured device. Therefore, the success rate of face recognition can be improved.

It should be noted that the face-recognition apparatus provided by some embodiments may be a module or a unit of the server shown in FIG. 1.

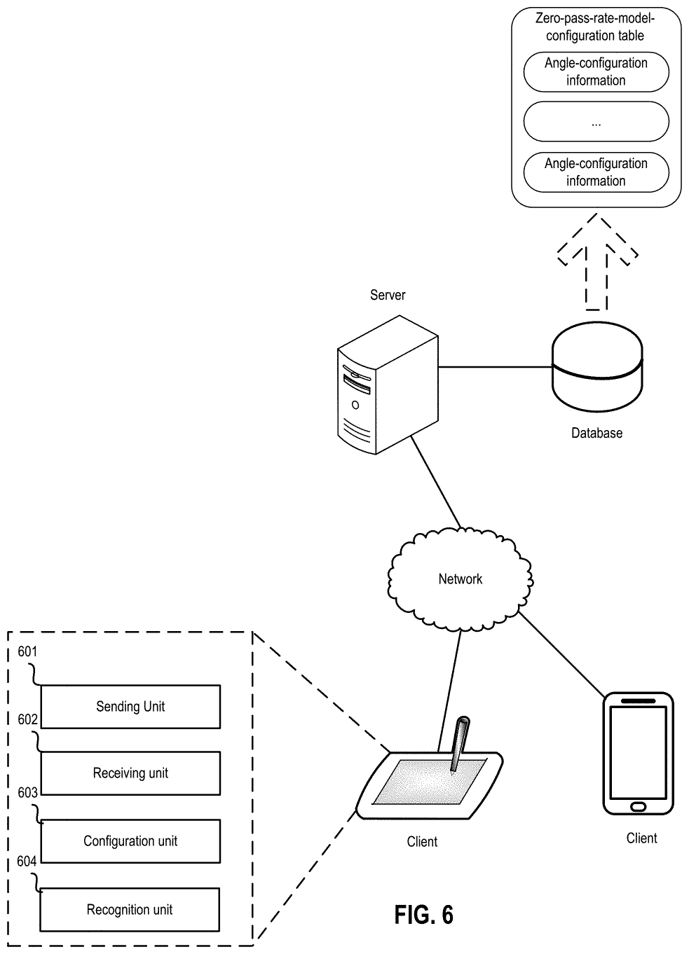

An embodiment can further provide a face-recognition apparatus corresponding to the aforementioned face-recognition method. As shown in FIG. 6, the apparatus can include:

a sending unit 601 configured to send a face-recognition request to a server, where the face-recognition request includes a device model of a device, in which the face-recognition apparatus is located, and the face-recognition request is configured to instruct the server to search a zero-pass-rate-model-configuration table for the device according to the device model;

a receiving unit 602 configured to receive a response returned by the server;

a configuration unit 603 configured to, configure the device according to the angle-configuration information, in response to the response received by the receiving unit 602 indicating that the device has been found and corresponding angle configuration information;

a recognition unit 604 configured to perform face recognition using the device configured by configuration unit 603.

Optionally, recognition unit 604 can be further configured to perform face recognition using a device with the default configuration, in response to the response received by receiving unit 602 includes only information used to indicate that the device has been found.

Optionally, the apparatus may further include:

an acquisition unit 605 configured to acquire a rotation angle of a built-in view of the device, in response to the response received by receiving unit 602 including information used to indicate that the device is not found;

a determination unit 606 configured to determine angle-configuration information of the device according to the rotation angle of the built-in view acquired by acquisition unit 605.

Configuration unit 603 can be further configured to configure the device according to the angle-configuration information determined by determination unit 606.

Recognition unit 604 can be further configured to perform face recognition using the device configured by configuration unit 603.

The functions of functional modules of the apparatus in the aforementioned embodiment can be implemented by the operations described in the aforementioned method embodiments. Therefore, a specific operation process of an apparatus provided by an embodiment will not be described herein again.

In the face-recognition apparatus provided by an embodiment, sending unit 601 sends the face-recognition request to the server. Receiving unit 602 receives the response returned by the server. If the response indicates that the device has been found and includes corresponding angle-configuration information, configuration unit 603 configures the device according to the angle-configuration information. Recognition unit 604 performs face recognition using the configured device. Therefore, the success rate of face recognition can be improved.

It should be noted that the face-recognition apparatus provided by the embodiments may be a module or a unit of the client in FIG. 1.

Those skilled in the art may be aware that, in the aforementioned one or plurality of examples, the functions described in the specification can be implemented by hardware, software, firmware, or any combination thereof. When implemented by software, these functions may be stored in a computer-readable medium, or transmitted as one or a plurality of instructions or as one or a plurality of pieces of code in the computer-readable medium.

The objectives, the technical solutions, and the beneficial effects of the embodiments are further described in detail in the foregoing specific implementations. It should be understood that the foregoing descriptions are merely specific implementation of the embodiments, and are not intended to limit the protection scope of the present disclosure. Any modification, equivalent replacement, and improvement made on the basis of the technical solutions of the disclosure shall fall within the protection scope of the disclosure.

1. A face-recognition method, comprising:
receiving, from a client, a face-recognition request, wherein the face-recognition request comprises a device model of a device where the client is residing;
searching a zero-pass-rate-model-configuration table for the device according to the device model, wherein the zero-pass-rate-model-configuration table is configured to store corresponding relationships between device models having a zero face-recognition pass rate and angle-configuration information, and wherein the angle-configuration information is determined according to data recorded by an event-tracking mechanism of the client while capturing a user performing a face-recognition operation;
in response to finding the device in the zero-pass-rate-model-configuration table, obtaining angle-configuration information corresponding to the device model; and
returning the angle-configuration information to the client, thereby facilitating the client in configuring the device according to the angle-configuration information and performing face recognition using the configured device.

2. The method of claim 1,
wherein the angle-configuration information comprises: a display-rotation angle and an algorithm-recognition angle;
wherein the method further comprises generating the zero-pass-rate-model-configuration table; and
wherein generating the zero-pass-rate-model-configuration table comprises:
acquiring an angle-adjustable device having a zero face-recognition pass rate;
determining whether the angle-adjustable device has a corresponding algorithm output value, wherein the algorithm output value is outputted when the angle-adjustable device performs face recognition successfully;
if so, acquiring a current recognition angle of the angle-adjustable device and using the current recognition angle as the algorithm-recognition angle, wherein the current recognition angle refers to an angle used during face recognition performed by the angle-adjustable device using a face-recognition algorithm;
if not, acquiring a current recognition angle of the angle-adjustable device and correcting the current recognition angle to obtain the algorithm-recognition angle;
determining whether a face displayed in a display of the angle-adjustable device is inverted;
if so, acquiring a current rotation angle of the display and correcting the current rotation angle to obtain the display-rotation angle;
if not, acquiring a current rotation angle of the display and using the current rotation angle as the display-rotation angle; and
generating the zero-pass-rate-model-configuration table according to the device model of the angle-adjustable device having a zero face-recognition pass rate, the algorithm-recognition angle, and the display-rotation angle.

3. The method of claim 2, wherein acquiring the device having a zero face-recognition pass rate comprises:
acquiring a plurality of devices in advance;
for each of the plurality of devices, acquiring user-behavior data corresponding to the device, wherein the user-behavior data is recorded by the event-tracking mechanism of the client when capturing the user starting the face-recognition operation and completing the face-recognition operation and/or abandoning the face-recognition operation using the device;
determining a face-recognition pass rate of each device according to the user-behavior data corresponding to each device; and
selecting a device having a zero face-recognition pass rate from the plurality of devices.

4. The method of claim 2, wherein determining whether a face displayed in a display of the device is inverted comprises:
acquiring sensor data of the device and display data of the face captured by a camera associated with the device, wherein the sensor data and the display data are recorded by the event-tracking mechanism of the client when capturing the device performing face recognition successfully using default configuration; and
determining, according to the sensor data and the display data, whether the face displayed in the display is inverted.

5. A face-recognition method, comprising:
sending, from a client a face-recognition request to a server, wherein the face-recognition request comprises a device model of a device where the client is residing, and wherein the face-recognition request is configured to instruct the server to search a zero-pass-rate-model-configuration table for the device according to the device model;
receiving a response from the server;
if the response comprises information indicating that the device has been found and corresponding angle-configuration information, configuring the device according to the angle-configuration information; and
performing face recognition using the configured devices.

6. The method of claim 5, further comprising:
if the response comprises only information indicating that the device has been found, performing face-recognition using a default configuration.

7. The method of claim 5 or 6, further comprising:
if the response comprises information indicating that the device is not found, acquiring a rotation angle of a built-in view of the device;
determining angle-configuration information of the device according to the rotation angle of the built-in view;
configuring the device according to the determined angle-configuration information; and
performing face recognition using the configured device.

8. A face-recognition apparatus, comprising:
a receiving unit configured to receive a face-recognition request from a client, wherein the face-recognition request comprises a device model of a device where the client is residing;
a search unit configured to search a zero-pass-rate-model-configuration table for the device according to the device model received by the receiving unit, wherein the zero-pass-rate-model-configuration table is configured to store corresponding relationships between device models having a zero face-recognition pass rate and angle configuration information, and the angle-configuration information is determined according to data recorded by an event-tracking mechanism of the client when capturing a user performing a face-recognition operation;
an acquisition unit configured to, in response to the search unit finding the device, acquire angle-configuration information corresponding to the device model; and
a sending unit configured to return to the client the angle-configuration information acquired by the acquisition unit, thereby facilitating the client in configuring the device according to the angle-configuration information and performing face recognition using the configured device.

9. The apparatus of claim 8, wherein the angle-configuration information comprises: a display-rotation angle and an algorithm-recognition angle; wherein the apparatus further comprises a generation unit; and
wherein the generation unit is configured to:
acquire an angle-adjustable device having a zero face-recognition pass rate;
determine whether the angle-adjustable device has a corresponding algorithm output value, wherein the algorithm output value is outputted when the angle-adjustable device performs face recognition successfully;
if so, acquire a current recognition angle of the angle-adjustable device and use the current recognition angle as the algorithm-recognition angle, wherein the current recognition angle refers to an angle used during face recognition performed by the angle-adjustable device by using a face-recognition algorithm;
if not, acquire a current recognition angle of the angle-adjustable device, and correct the current recognition angle to obtain the algorithm-recognition angle;
determine whether a face displayed in a display of the angle-adjustable device is inverted;
if so, acquire a current rotation angle of the display, and correct the current rotation angle to obtain the display-rotation angle;
if not, acquire a current rotation angle of the display, and use the current rotation angle as the display-rotation angle; and
generate the zero-pass-rate-model-configuration table according to the device model of the angle-adjustable device having a zero face-recognition pass rate, the algorithm-recognition angle, and the display-rotation angle.

10. The apparatus of claim 9, wherein the generation unit is configured to:
acquire a plurality of devices in advance;
for each of the plurality of devices, acquire user-behavior data corresponding to each device, wherein the user-behavior data is recorded by the event-tracking mechanism of the client when capturing the user starting a face-recognition operation and completing the face-recognition operation and/or abandoning the face recognition operation using the device;
determine a face-recognition pass rate of each device according to the user-behavior data corresponding to each device; and
select a device having a zero face-recognition pass rate from the plurality of devices.

11. The apparatus of claim 9, wherein the generation unit is further configured to:
acquire sensor data of the device and display data of the face captured by a camera associated with the device, wherein the sensor data and the display data are recorded by the event-tracking mechanism of the client when capturing the user performing face recognition successfully using a default configuration; and
determine, according to the sensor data and the display data, whether the face displayed in the display is inverted.

12. A face-recognition apparatus, comprising:
a sending unit configured to send a face-recognition request to a server, wherein the face recognition request comprises a device model of a device in which the face-recognition apparatus is located, and wherein the face-recognition request is configured to instruct the server to search a zero-pass-rate-model configuration table for the device according to the device model;
a receiving unit configured to receive a response from the server;
a configuration unit configured to, if the response received by the receiving unit comprises information indicating that the device has been found and corresponding angle-configuration information, configure the device according to the angle-configuration information; and
a recognition unit configured to perform face recognition using the device configured by the configuration unit.

13. The apparatus of claim 12, wherein the recognition unit is further configured to, if the response received by the receiving unit comprises only information indicating that the device has been found, perform face recognition using a default configuration.

14. The apparatus of claim 12, further comprising:
an acquisition unit configured to, if the response received by the receiving unit comprises information indicating that the device is not found, acquire a rotation angle of a built-in view of the device; and
a determination unit configured to determine angle-configuration information of the device according to the rotation angle of the built-in view acquired by the acquisition unit, wherein
the configuration unit is further configured to configure the device according to the angle-configuration information determined by the determination unit;
the recognition unit is further configured to perform face recognition using the device configured by the configuration unit.

15. The method of claim 1, wherein the device implements an Android™ operating system.

16. The method of claim 5, wherein the device implements an Android™ operating system.

17. The method of claim 5, wherein the zero-pass-rate-model-configuration table is configured to store corresponding relationships between device models having a zero face-recognition pass rate and angle configuration information.

18. The apparatus of claim 8, wherein the device implements an Android™ operating system.

19. The apparatus of claim 12, wherein the device implements an Android™ operating system.

20. The apparatus of claim 12, wherein the zero-pas s-rate-model-configuration table is configured to store corresponding relationships between device models having a zero face-recognition pass rate and angle configuration information.
